(19) United States
(12) Patent Application Publication
(10) Pub. No.: US 2011/0086558 A1
(43) Pub. Date: Apr. 14, 2011

(54) ELECTRICAL CONTACT WITH IMPROVED MATERIAL AND METHOD MANUFACTURING THE SAME

(75) Inventors: Chih-Pi Cheng, Tu-Cheng (TW); Cheng-Ching Chien, Tu-Cheng (TW); Jia-Hau Liu, Tu-Cheng (TW); Been-Yang Liaw, Tu-Cheng (TW)

(73) Assignee: HON HAI PRECISION INDUSTRY CO., LTD., Tu-Cheng (TW)

(21) Appl. No.: 12/904,174

(22) Filed: Oct. 14, 2010

(30) Foreign Application Priority Data
Oct. 14, 2009 (TW) 98134713

(51) Int. Cl. H01R 13/02; B05D 5/12

(52) U.S. Cl. 439/886; 427/123

(57) ABSTRACT

An electrical contact material includes a base material, a first number of plating layers forming a contact section and a second number of plating layers forming a soldering section, respectively. The second number of plating layers is provided on the base material and includes a Ni-plating layer directly on the base material and an organic antioxidant-plating layer on said Ni-plating layer.

### BACKGROUND OF THE INVENTION

1. Field of the Invention

The present invention relates to an electrical contact, and particularly to an electrical contact having improved material.

2. Description of Related Art

Electrical contacts are used in electrical connectors for providing electrical connection between two electronic elements such as central process unit (CPU) and printed circuit board (PCB). Generally, the electrical contact comprises a contact section for connecting with the CPU and a soldering section for connecting with the PCB. Surface mount technology (SMT) is a popular method for soldering the soldering section of the electrical contact and a conductive pad on the printed circuit board.

In a traditional method, solders are pre-loaded on the soldering sections of the contacts by a first reflow process. Then, the contacts with the solders thereon need a second reflow process to mount to the PCB. Therefore, this traditional method needs two reflow processes for conducting the soldering. In recent days, another mechanical method which eliminates the first reflow process is also applied due to manufacturing cost. The solders are secured by the electrical contact and pre-set thereon instead of reflow before soldering to the PCB.

It is known to the skilled in the art that a material having an Ni-plating layer provided on a base material composed of Cu or a Cu alloy such as brass is used as a material used for production of the electrical contact. However, the contact formed from aforementioned material having a Ni-plating layer has a disadvantage that if the contact is used under a high temperature for a long time, an oxide film is produced on a contact surface, that is on a surface of the Ni-plating layer, to thereby increase contact resistance. This problem becomes serious when the solders are mechanically pre-set on the electrical contact. As a material to eliminate the aforementioned disadvantage, an Au-plating layer is provided on the Ni-plating layer. However, the Au as a noble metal also remains a cost challenge to the electrical connector manufacturers.

Therefore, it is needed to provide an improved electrical contact to overcome the disadvantages mentioned above.

### BRIEF SUMMARY OF THE INVENTION

The present invention provides an electrical contact for cost reduction and reliability.

An electrical contact comprises a base material, a first plurality of plating layers forming a contact section and a second plurality of plating layers forming a soldering section, respectively. The first plurality of plating layers and the second plurality of plating layers are provided on the base material. The first plurality of plating layers includes a Ni-plating layer directly on the base material and an Au-plating layer on the Ni-plating layer. The second plurality of plating layers includes a Ni-plating layer directly on the base material and an organic antioxidant-plating layer on said Ni-plating layer.

A process for manufacturing an electrical contact comprises a loading material step to load an electrical contact with a base material, an alkalidipping step for wiping off the dirty on the base material, a pickling step for cleaning the oxidant on the base material, a plating step, and an unloading step to unload the electrical contact. The plating step comprises a Ni plating step on the base material and an organic antioxidant plating step after the Ni plating step.

Other objects, advantages and novel features of the invention will become more apparent from the following detailed description of the present embodiment when taken in conjunction with the accompanying drawings.

### BRIEF DESCRIPTION OF THE DRAWINGS

FIG. 1 is a perspective view of an electrical contact according to the present invention;

FIG. 2 is a perspective view of an electrical contact according to a second embodiment of the present invention;

FIG. 3 is schematic sectional view showing a contact section material of the contact according to the present invention;

FIG. 4 is schematic sectional view showing a soldering and body section material of the contact according to the present invention;

FIG. 5 is a flow chart showing the plating process of the electrical contact;

FIG. 6 is a flow chart showing the detail plating process of the contact section; and

FIG. 7 is a flow chart showing the detail plating process of the body section and soldering section.

### DETAILED DESCRIPTION OF THE PREFERRED EMBODIMENT

Reference will be made to the drawing figures to describe the present invention in detail, wherein depicted elements are not necessarily shown to scale and wherein like of similar elements are designated by same or similar reference numeral through the several views and same or similar terminology.

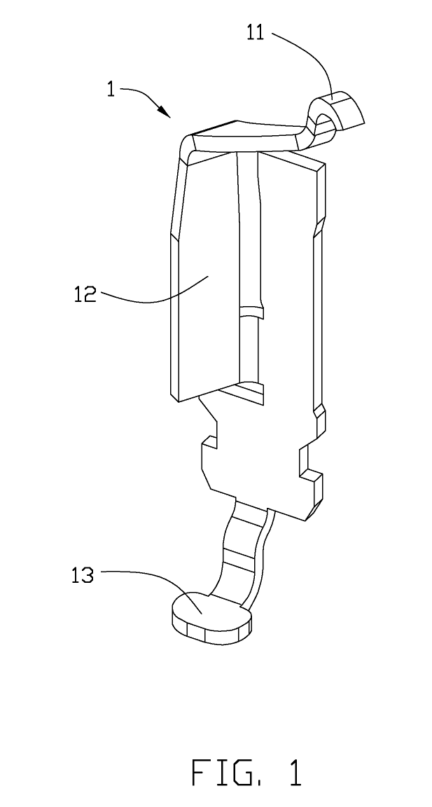

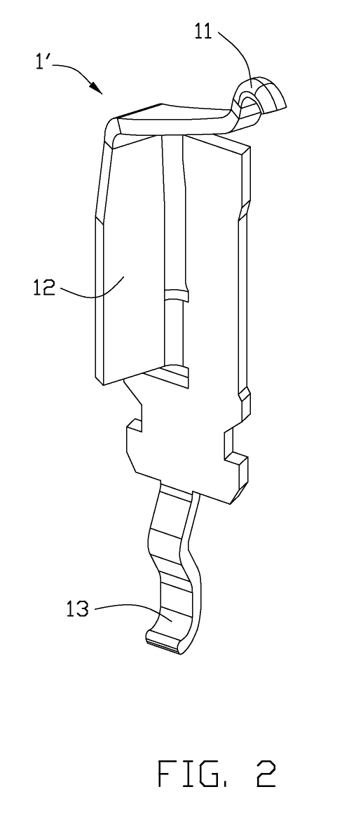

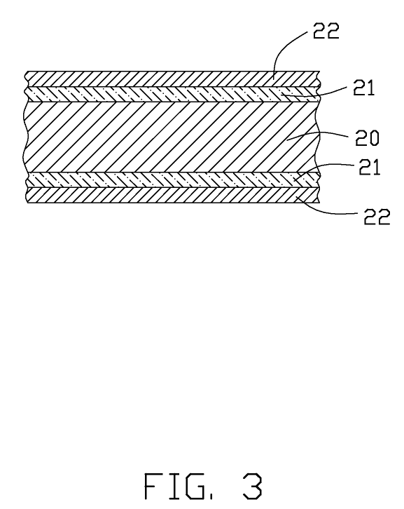

Please referring to FIGS. 1 and 2, the two types of electrical contacts 1, 1′ according to the present invention each comprises a contact section 11 for electrically connecting with a first electronic element (not shown), a soldering section 13 for mounting to a printed circuit board (PCB, not shown), and a body section 12 located therebetween. Conjointed with FIG. 3, the electrical contact 1, 1′ uses Cu or Cu alloy as a base material 20. A Ni-plating layer 21 is provided on the base material 20. The contact section 11 is bent from the body section 12 and extends upwardly. The soldering section 13 extends from a bottom edge of the body section 12 for electrical connecting with a solder ball (not shown).

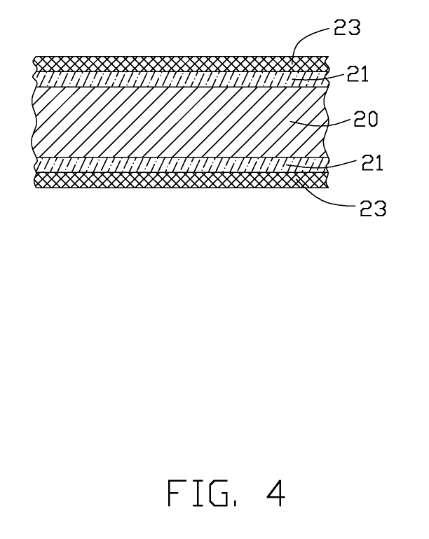

Please referring to FIG. 3, the contact section 11 includes the base material 20, the Ni-plating layer 21 on the base material 20, and an Au-plating layer 22 coated on the Ni-plating layer 21 for increasing conductivity of the electrical contacts 1, 1′. FIG. 4 shows material of the soldering section 13 and the body section 12, which comprises the base material 20, the Ni-plating layer 21, and an organic antioxidant layer 23 coated on the Ni-plating layer 21.

The organic antioxidant layer 23 is the outermost layer of the body section 12 and the soldering section 13 whereby preventing the Ni-plating layer 21 from oxidant. To the body portion 12, an antioxidant layer is provided thereon which not only avoids resistance increasing which is caused by the oxidant of Ni-plating layer 21 but also assures the transmitting reliability of high frequency signals. To the soldering portion 13, as an antioxidant, cost of organic antioxidant is less than Au thereby the organic antioxidant layer 23 can achieve cost reduction. However, the soldering section 13 of the electrical contact 1, 1′ could comprise an Au-plating layer between the Ni-plating layer 21 and the organic antioxidant layer 23 for improving conductivity thereof.

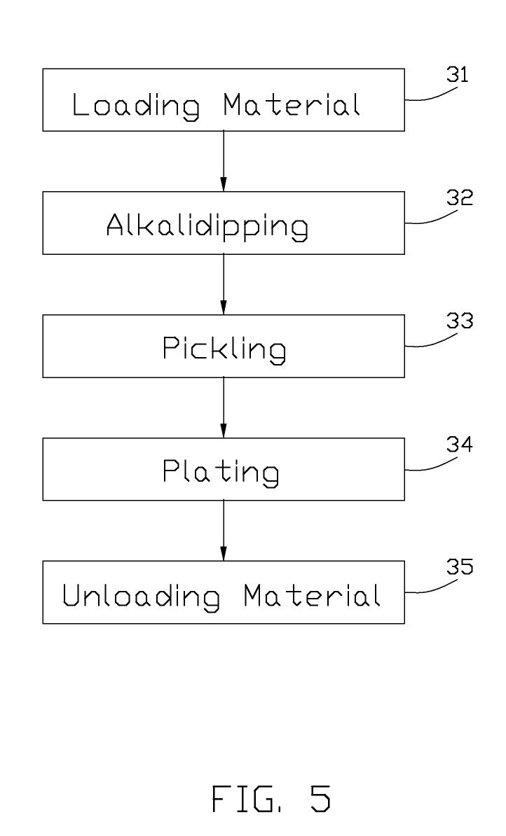

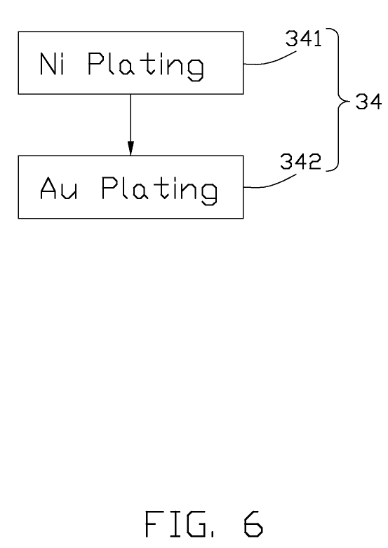

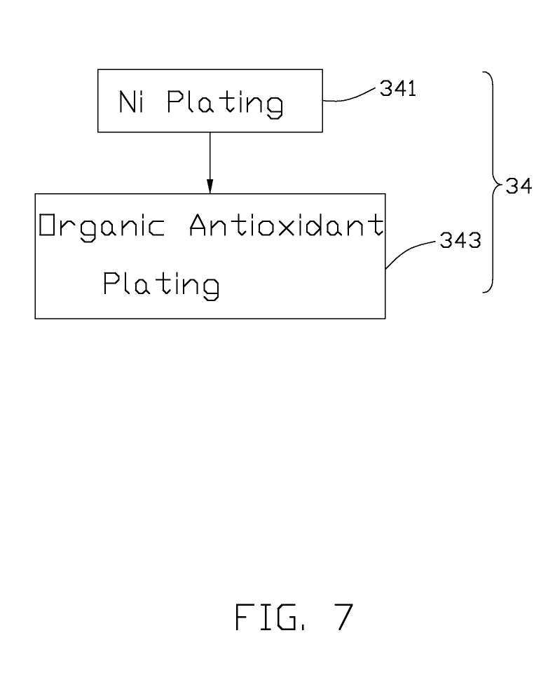

With respect to FIGS. 5-7, a preferred manufacturing process for preparing the contact 1, 1′ of this invention will now be disclosed. The general production sequence, described in FIG. 5, includes a loading material step 31 for providing a general contact shape, an alkalidipping step 32 for wiping off the dirty on the base material 20, and a pickling step 33 for cleaning the oxidant on the base material 20. Plating step 34 is provided which includes a Ni plating step 341 and an Au plating step 342 for the contact section 11 as shown in FIG. 6. To the body section 12 and the soldering section 13, the plating step 34 comprises a Ni plating step 341 and an organic antioxidant plating step 343 as disclosed in FIG. 7. A final unload material step 35 follows the plating step 34. The Au plating step 342 and the organic antioxidant plating step 343 can use brush plating to process for cost reduction. In addition, the contact section 11 also includes an organic antioxidant layer on the Au-plating layer 22.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

We claim:

1. An electrical contact comprising:
a base material; and
a first plurality of plating layers forming a contact section and a second plurality of plating layers forming a soldering section, respectively, said first plurality of plating layers and said second plurality of plating layers being provided on the base material;
said first plurality of plating layers including a Ni-plating layer directly on the base material and an Au-plating layer on the Ni-plating layer, said second plurality of plating layers including a Ni-plating layer directly on the base material and an organic antioxidant-plating layer on said Ni-plating layer.

2. The electrical contact according to claim 1, wherein the base material is formed of a material selected from Cu or Cu alloys.

3. The electrical contact according to claim 1, further comprising a body section, and wherein the contact section bent from the body section and extending upwardly therefrom, and the soldering section extends downwardly from a bottom edge of the body section.

4. The electrical contact according to claim 3, wherein the plating layers of the body section is the same as the soldering section.

5. The electrical contact according to claim 1, wherein the contact section includes an organic antioxidant layer on the Au-plating layer as an outermost plating layer thereof.

6. The electrical contact according to claim 1, wherein the soldering section comprises an Au-plating layer between the Ni-plating layer and the organic antioxidant-plating layer.

7. The electrical contact according to claim 1, wherein the soldering section is electrically connected with a solder ball.

8. A process for manufacturing an electrical contact, comprising:
a loading material step to load an electrical contact with a base material;
an alkalidipping step for wiping off the dirty on the base material;
a pickling step for cleaning the oxidant on the base material;
a plating step comprising a Ni plating step on the base material and an organic antioxidant plating step after the Ni plating step; and
an unloading step to unload the electrical contact.

9. The process according to claim 8, further comprising an Au plating step between the Ni plating step and the organic antioxidant plating step.

10. The process according to claim 8, wherein the base material is formed of a material selected from Cu or Cu alloys.

11. In a combination, comprising:
a conductive contact including an upper contacting section, a middle body and a lower soldering section,
each of the upper contacting section, the middle body and the lower soldering section defining two opposite faces each coated with an inner Ni layer and an outer organic antioxidant layer, wherein the upper contacting section is configured to contact an electrode of an electronic package while the soldering section is configured to contact a solder ball which is adapted to be melted for mounting a printed circuit board.

12. The combination as claimed in claim 11, wherein an Au layer is further provided between the inner Ni layer and the outer organic antioxidant layer on the contacting section while the soldering section not.
